(19) United States
(12) Patent Application Publication
(10) Pub. No.: US 2020/0061659 A1
(43) Pub. Date: Feb. 27, 2020

(54) Adjustable Escutcheon Assembly

(71) Applicant: Durst Corporation, Inc., Cranford, NJ (US)

(72) Inventors: Lawrence B. Brodey, South Orange, NJ (US); Christopher Pike, Princeton, NJ (US); Anthony Folk, Whitehouse Station, NJ (US)

(73) Assignee: Durst Corporation, Inc., Cranford, NJ (US)

(21) Appl. No.: 16/669,105

(22) Filed: Oct. 30, 2019

Related U.S. Application Data
(63) Continuation of application No. 15/630,484, filed on Jun. 22, 2017.

(51) Int. Cl. B05B 15/652; E03C 1/04; B05B 1/18; B05B 15/654; E03C 1/02

(52) U.S. Cl. CPC B05B 15/652; E03C 1/0408; B05B 1/18; E03C 2001/028; E03C 1/021; E03C 2201/50; B05B 15/654

(57) ABSTRACT

An adjustable escutcheon assembly is provided which can be installed flush against a ceiling or wall where a water supply pipe exits the ceiling or wall at various angles. The assembly includes a ball fitting having an aperture for receiving the water supply pipe exiting the wall or ceiling, a retainer which bears against and is adjustable with respect to the ball, and an escutcheon mountable to the retainer. During installation, the retainer and escutcheon can be angled with respect to the ball in order to allow flush installation of the retainer and escutcheon against a ceiling or wall at a variety of angles.

### RELATED APPLICATIONS

This application is a continuation of U.S. patent application Ser. No. 15/630,484 filed on Jun. 22, 2017, the entire disclosure of which is incorporated by reference herein.

### BACKGROUND

### Field of the Invention

The present disclosure relates to decorative escutcheons for plumbing equipment. More specifically, the present disclosure relates to an adjustable escutcheon assembly that can be used with water supply pipes oriented at various angles with respect to wall surfaces.

### Related Art

A shower head is normally installed with a water supply pipe which provides water to the shower head. Such pipe normally extends outwardly from a wall or a ceiling, often normal to (i.e., at a 90 degree angle to) the wall or ceiling through which the pipe extends. The point at which the pipe exits the wall can look undesirable due to the hole through which the pipe extends. Because of this, decorative escutcheons are frequently used to conceal such holes, thereby providing a pleasing appearance.

However, if the pipe exits the wall or ceiling at an angle other than 90 degrees to the wall, (i.e., the pipe is not perpendicular to the wall or ceiling through which it extends), an escutcheon often cannot be used because escutcheons are often only designed for installation with pipes that are perpendicular to the wall or ceiling. Thus, if the pipe is at an angle other than 90 degrees to the wall or ceiling, the geometry of the pipe will not allow the pipe to fit through in the hole of the escutcheon, thereby preventing installation of the escutcheon. Accordingly, what is desirable is an adjustable escutcheon assembly which addresses the foregoing needs.

### SUMMARY

An adjustable escutcheon assembly is provided which can be installed flush against a ceiling or wall where a water supply pipe exits the ceiling or wall at various angles (e.g, including angles other than 90 degrees to the ceiling or wall, as well as angles of 90 degrees to the ceiling or wall). The assembly includes a ball fitting having an aperture for receiving the water supply pipe exiting the wall or ceiling, a retainer which bears against and is adjustable with respect to the ball, and an escutcheon mountable to the retainer. During installation, the retainer and escutcheon can be angled with respect to the ball in order to allow flush installation of the retainer and escutcheon against a ceiling or wall at a variety of angles.

### BRIEF DESCRIPTION OF THE DRAWINGS

The foregoing features and others will be apparent from the following Detailed Description, taken in connection with the accompanying drawings, in which:

FIG. 1 is an exploded view of the assembly of the present disclosure;

FIGS. 2-4 are side views illustrating installation of the assembly in connection with walls/ceilings at various angles to the water supply pipe; and

FIG. 5 is a cross-sectional view of the assembly of the present disclosure.

### DETAILED DESCRIPTION OF THE INVENTION

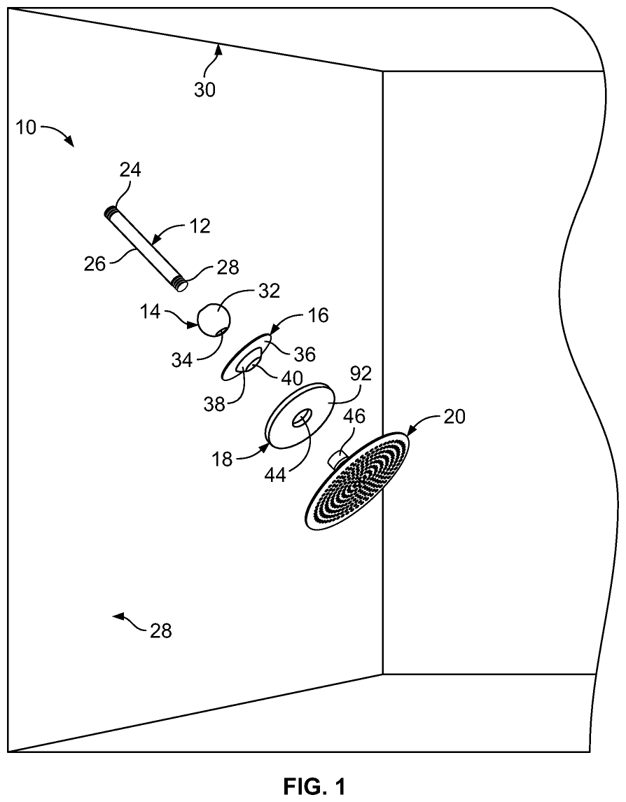

The present invention relates to an adjustable escutcheon assembly, as discussed in detail below in connection with FIGS. 1-5.

FIG. 1 is an exploded view of an assembly 10 of the present disclosure. The assembly 10 includes a ball fitting 14 which receives a water supply pipe 12, a retainer 16 that bears against and is adjustable with respect to the ball fitting 14, and a decorative escutcheon plate 18. The ball fitting 14 includes an aperture 34 and a curved bearing surface 32. The aperture 34 receives the water supply pipe 12 (which extends through the aperture 34), such that the central portion 26 of the pipe (between threaded ends 22 and 24 of the pipe) extends through the aperture 34. The threads 22 mate with a threaded connector 46 of a conventional shower head 20.

The pipe 12 also extends through an aperture 40 formed in the retainer 16. The retainer 16 includes a bearing surface 38 which bears against, and is adjustable with respect to, the bearing surface 32 of the ball fitting 14. A peripheral flange 36 is provided, and is attached to (or formed integrally with) the bearing surface 38. An interchangeable escutcheon plate 18 is also provided, and is mounted to the retainer 16. The escutcheon plate 18 includes a central aperture 44 (through which the pipe 12 extends), and a peripheral portion 42. The plate 18 could include any desired decorative surface, ornamentation, etc., in order to provide a desired aesthetic look. Both the retainer 16 and the plate 18 rotate so as to allow flush installation against a wall 28 or a ceiling 30 through which the pipe 12 extends, as discussed in greater detail below.

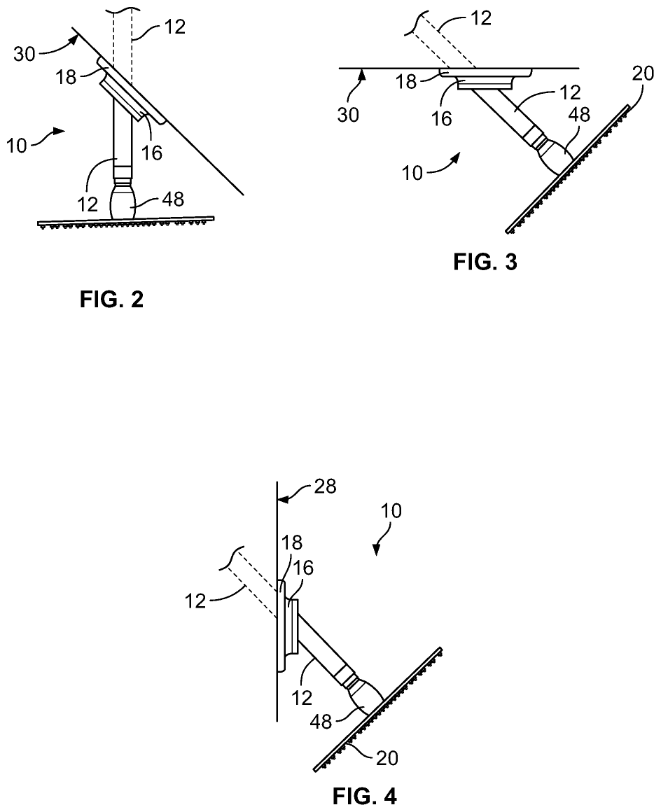

FIGS. 2-4 are side views illustrating installation of the adjustable escutcheon assembly in various configurations. For example, as illustrated in FIG. 2, the ceiling 30 is at an angle of roughly 45 degrees with respect to the pipe 12. As can be seen, since the retainer 16 and the plate 18 can rotate with respect to the pipe 12 (bearing and rotating against the ball 14, not shown in FIG. 2), both components can be installed flush against the ceiling 30. It is noted that the configuration shown in phantom (dotted) lines in FIG. 2 illustrates how a conventionally-installed pipe normally exists, such that the pipe is perpendicular to the ceiling 30. As can be appreciated the adjustable escutcheon assembly of the present invention can be used with pipes that are installed at various angles with respect to a wall or ceiling, including perpendicular as well as non-perpendicular pipe angles. For example, as illustrated in FIGS. 3-4, the adjustable angle escutcheon assembly allows for installation of the retainer 16 and plate 18 flush against a horizontal ceiling 30 as shown in FIG. 3, and against a vertical wall 28 as shown in FIG. 4. As can be seen in the illustrations shown in FIGS. 3-4, the pipe 12 is installed at various angles (e.g., non-perpendicular angles) with respect to the ceiling 30 and the wall 28.

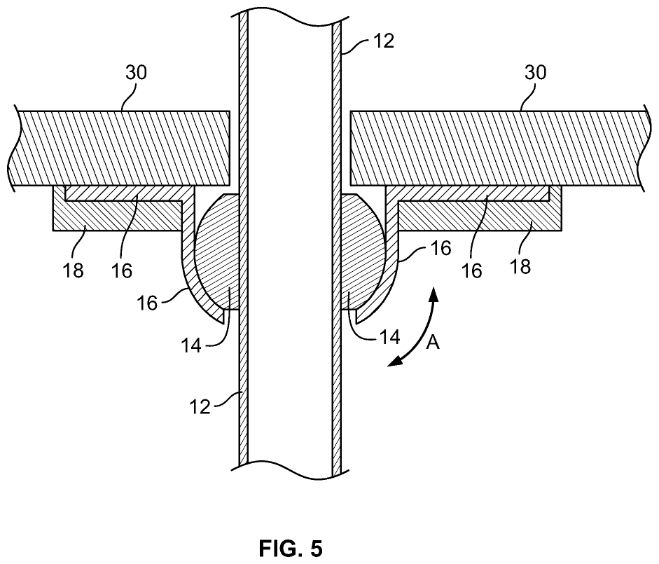

FIG. 5 is cross-sectional view showing the adjustable escutcheon assembly in greater detail. As can be seen, the pipe 12 extends through an aperture in the ceiling 30, as well as through the ball 14, the retainer 16, and the decorative escutcheon plate 18. The retainer 16 bears against the ball 14, and is mounted flush against the ceiling 30 using any suitable means such as adhesives, screws, bolts, etc. When the retainer 16 is installed against the ceiling 30, it captures the ball 14 in position between the ceiling 30 and the retainer 16. The escutcheon plate 18 is attached to the retainer 16, and can be held in place against the retainer 16 using any suitable means, such as a friction fit, protrusions and corresponding recesses, set screw(s), adhesives, etc. Both the retainer 16 and the plate 18 can rotate with respect to the bearing 14 as illustrated by arrow A, thereby accommodating the angle formed between the wall 30 and the pipe 12. Thus, the assembly can accommodate various angles formed between the pipe 12 and the wall 30, including perpendicular and, importantly, non-perpendicular angles.

It is noted that the ball fitting 14, the retainer 16, and the decorative escutcheon plate 18 could be formed of any suitable materials such as metal (e.g., copper, brass, stainless steel, etc.), plastics, or other suitable materials as desired. Further, it is noted that the plate 18 is interchangeable with the retainer 16, so that a variety of different plates having different ornamental appearances could be utilized with the retainer 16.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention.

What is claimed is:

1. An adjustable escutcheon assembly, comprising:
a ball fitting having a central aperture for receiving a pipe and a curved bearing surface;
a retainer plate mountable to a surface of a wall or a ceiling through which the pipe extends, the retainer plate bearing against and rotatable with respect to the curved bearing surface of the ball fitting; and
a decorative escutcheon plate mounted to the retainer plate,
wherein the retainer plate and the decorative escutcheon plate are adjustable with respect to the ball fitting to accommodate an angle formed between the pipe and the surface of the wall or the ceiling, and wherein the retainer plate and the decorative escutcheon plate contact the surface of the wall or the ceiling.

2. The escutcheon assembly of claim 1, wherein the ball fitting is captured between the retainer plate and the surface of the wall or ceiling when the retainer plate is mounted to the surface of the wall or the ceiling.

3. The escutcheon assembly of claim 1, wherein the retainer plate includes a second curved bearing surface which bears against the curved bearing surface of the ball fitting.

4. The escutcheon assembly of claim 3, wherein the retainer plate includes a peripheral flange attached to or formed integrally with the second curved bearing surface.

5. The escutcheon assembly of claim 1, wherein the decorative escutcheon plate is removably attached to the retainer plate.

6. The estucheon assembly of claim 1, wherein the ball fitting, the retainer plate, and the escutcheon plate are formed from metal.

7. The estucheon assembly of claim 1, wherein the ball fitting, the retainer plate, and the escutcheon plate are formed from plastic.

8. The escutcheon assembly of claim 1, further comprising a shower head attached to the pipe.

9. The escutcheon assembly of claim 1, wherein the pipe comprises a water supply pipe.
